(19) United States
(12) Patent Application Publication
(10) Pub. No.: US 2026/0126364 A1
(43) Pub. Date: May 7, 2026

(54) SYSTEM AND METHOD OF USING AN INTEGRATED PARTICLE, GAS, AND VAPOR SENSOR FOR FIRE, AIR, HEALTH, & SAFETY MONITORING

(71) Applicant: SAAM, Inc., Carmel, IN (US)

(72) Inventors: Erik R. Deutsch, Brookline, MA (US); Jason Booth, Assonet, MA (US)

(21) Appl. No.: 19/210,661

(22) Filed: May 16, 2025

Related U.S. Application Data
(60) Provisional application No. 63/648,442, filed on May 16, 2024.

(51) Int. Cl. G01N 15/0205; G01N 15/00

(52) U.S. Cl. CPC G01N 15/0211; G01N 2015/0046

(57) ABSTRACT

The disclosed technology relates, in general, to chemical and particulate matter detectors. Embodiments may include a particulate detector for detecting multiple hazards, comprising: a gas cell; one or more energy emitters mounted within an interior of the gas cell; plurality of mirrors along the interior of the gas cell; and one or more energy detectors capable of detecting an amount of energy.

### CROSS-REFERENCE TO RELATED APPLICATIONS

This application claims priority from U.S. Provisional Patent Application No. 63/648,442, filed May 16, 2024, the disclosure of which is incorporated herein by reference in its entirety.

### BACKGROUND

This application claims priority from U.S. Provisional Patent Application No. 63/648,442, filed May 16, 2024.

Particle detection is a key component of ensuring safety in some environments. Particle detection can ensure environmental safety on its own or by augmenting the measurements of smoke, gas, vapor, or other hazards in the environment.

For reasons stated above, and for other reasons which will become apparent to those skilled in the art upon reading the present specification, there is a need for systems and methods that provide for detecting hazards through particle, gas, vapor, smoke detection. There is a particular need for detecting hazards through a singular detector such that one detector can determine a variety of hazards such as gas, fire, poor air quality, other hazards, and combinations thereof. The disclosed technology fulfills these and other needs and addresses deficiencies in known systems and techniques.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 depicts a top-down view of light being reflected around a gas cell embodiment. In this figure, light reflects around the cell with every other pass hitting a neighboring mirror;

FIG. 2A depicts a top-down view of an “In-Plane” gas cell embodiment showing an emitter and detector mounted on opposite sides of a gas cell;

FIG. 2B depicts cross-sectional view of an “In-Plane” gas cell embodiment showing an emitter and detector mounted on opposite sides of a gas cell;

FIG. 3A depicts a top-down view of a “Perpendicular-to-Plane” gas cell embodiment;

FIG. 3B depicts a cross-sectional view of a “Perpendicular-to-Plane” gas cell embodiment;

FIG. 4A depicts a top-down view of an “At-Angle-to-Plane” gas cell embodiment;

FIG. 4B depicts a cross-sectional view of an “At-Angle-to-Plane” gas cell embodiment;

FIG. 4C depicts a three-dimensional view of the “At-Angle-to-Plane” gas cell embodiment;

FIG. 5A depicts a top-down view of another “in plane” gas cell embodiment; and

FIG. 5B depicts a cross-sectional view of another “in plane” gas cell embodiment.

### DETAILED DESCRIPTION

Various non-limiting embodiments of the present disclosure are now described to provide an overall understanding of the principles of the structure, function, and use of the systems and methods as disclosed herein. One or more examples of these non-limiting embodiments are illustrated in the accompanying drawings. Those of ordinary skill in the art may understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment can be included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination cannot be possible. Also, for any methods described, regardless of whether the method can be described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Safety is critical in both commercial and residential spaces. One way safety is ensured in a space is through the use of devices that detect potential hazards like poor air quality, fire, gas, or other hazards that may impact the space. Typically, multiple detectors are used to achieve this sense of safety. Often there is a device or detector for each potential hazard a space may encounter. One device that could detect multiple hazards may be beneficial because it may save space, time, and money, among other benefits.

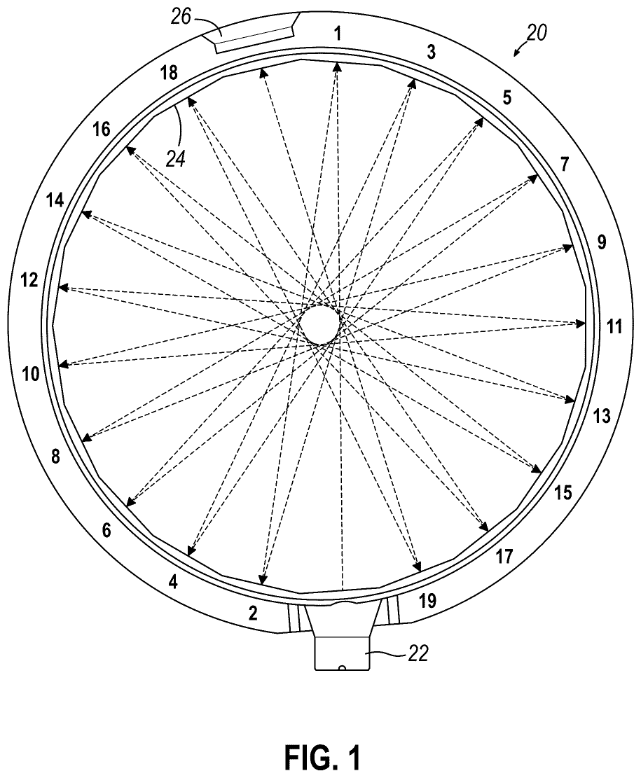

FIG. 1 depicts a top-down view of light being reflected around a gas cell (20). In one or more embodiments, at least one emitter (22) emits light, or other energy, into the gas cell (20). In one or more embodiments, emitter (22) may be any object that emits energy, either in a pulsed or continuous fashion in a measurable manner at a wavelength in a range where absorption by a chemical can be used for detection. In one or more embodiments, emitter (22) can be filament or deposited material-based emitter. In one or more embodiments, emitter (22) may be a filament-based emitter utilizing materials such as Kanthal, Tungsten, or Silicon Carbide and can be wound in cylindrical coils or can be in ribbon form with a nanostructured surface. In one or more embodiments, emitter (22) may be a deposited-material based emitter that can be thin-film or nanostructured. These can include MEMS thin-film resistors on a MEMS membrane and can employ carbon nanotube or nanostructured amorphous carbon to boost emission. In one or more embodiments, emitter (22) can be a wavelength swept quantum cascade lasers (QCLs) or an infrared light emitting diodes (LEDs). In one or more embodiments, emitter (22) may be a microelectromechanical system, LED, laser, emitter of ultraviolet, visible, near infrared (about 0.75 to about 1.4 um), mid-wave infrared (about 2.5 to about 6 um), long-wave infrared (about 6 to about 12 um), short-wave infrared (about 1.4 to about 3 um), or another wavelength light, or another emitter. In one embodiment, emitter (22) may use mid-wave infrared and/or long-wave infrared wavelengths.

The light from emitter (22) reflects around gas cell (20), bouncing off of mirrors (1-19) such that every other pass hits a neighboring mirror (1-19). The light may reflect around with every other pass hitting every second, or more, neighboring mirrors (1-19), although the increased angles can cause astigmatism. This reflection process forms a light path (24) that ends with the light reflecting into a detector (26). Detector (26) then can determine the amount of light that made it through light path (24). The light may decrease due to its interaction with the mirrors, but light may be absorbed throughout the interaction by gas within gas cell (20). Thus, detector (26) could determine the amount of light that made it through light path (24).

In one or more embodiments, detector (26) can be made from any material which responds to the energy incident on it in a measurable manner that can be used for chemical detection. In one or more embodiments, detector (26) may be one or more of a pyroelectric detector, a thermopile detector, a PVSE detector, a lead selenide (PbSe) detector, a lead sulfide (PbS) detector, an indium gallium arsenide (InGaAs) detector, a Mercury Cadmium Telluride (MCT) detector, or combinations thereof.

In one or more embodiments, gas cell (20) may also contain a laser or other second emitter of a sufficient wavelength such that when the second emitter emits light across gas cell (20), detector (26) may detect scattered light. Particulate matter causes light to scatter, so by detecting the scattered light, detector (26) may be able to detect particulate matter like smoke or other particulate matter.

In one or more embodiments, each emitter (22) utilized within gas cell (20) may include a reference channel and one or more gas channels. This may also include any second emitter utilized within gas cell (20), which may also include a reference channel and one or more gas channels. The difference between emitter (22) and a second emitter is that the amount of gas is different (due to the different path length) so different absorptions are seen based on the difference in path length.

Instead of a laser or other second emitter, gas cell (20) may contain an additional detector that detects scattered light as emitter (22) emits light through gas cell (20). This may allow additional detector to determine if there may be particulate matter present in gas cell (20).

Another way to detect particulate matter may be to detect a reduced signal from emitter (22) when the light from emitter (22) hits detector (26) or additional detector if present.

One or more gas cell (20) may be created using datums and alignment features on molded elements. The molded elements may be pushed actively against a highly precise datum. Then all parts of gas cell (20) may be fixed into their desired position. The molded elements of gas cell (20) may include optical portions and portions that are flat. In one or more embodiments, a highly precise machined fixture may be utilized to push gas cell (20) up against the molded elements and a frame that is bonded to gas cell (20) such that gas cell (20) may be held in that exact position. In one or more embodiments, the datums and alignment features on the molded elements may be used to align sections of gas cell (20) to each other such that they can be fixed to each other without the use of a highly precise machined fixture and/or other active alignment methods.

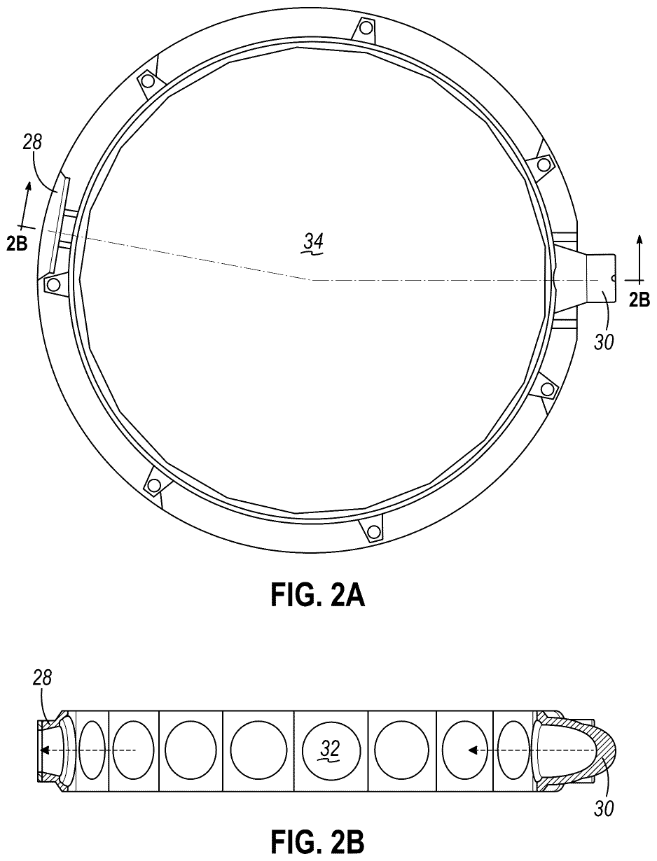

FIGS. 2A and 2B depict a top-down view and a cross-sectional view of an “In-Plane” gas cell (34) showing an emitter (30) and detector (28) mounted on opposite sides of gas cell (34). In this embodiment, there can be a direct light path from emitter (30) to detector (28). The cross-sectional view shows mirrors (32) and how light moves directly from emitter (30) across gas cell (34) to detector (28). This embodiment may allow detector (28) to determine the amount of light absorbed like in FIG. 1, but in this case instead of measuring the amount of light that made it through the light path that included bouncing off mirrors (32), detector (28) measures the light that made it directly across gas cell (34). This direct path increases the optical power that moves through gas cell (34), making it easier for detector (28) to get a sufficient reading.

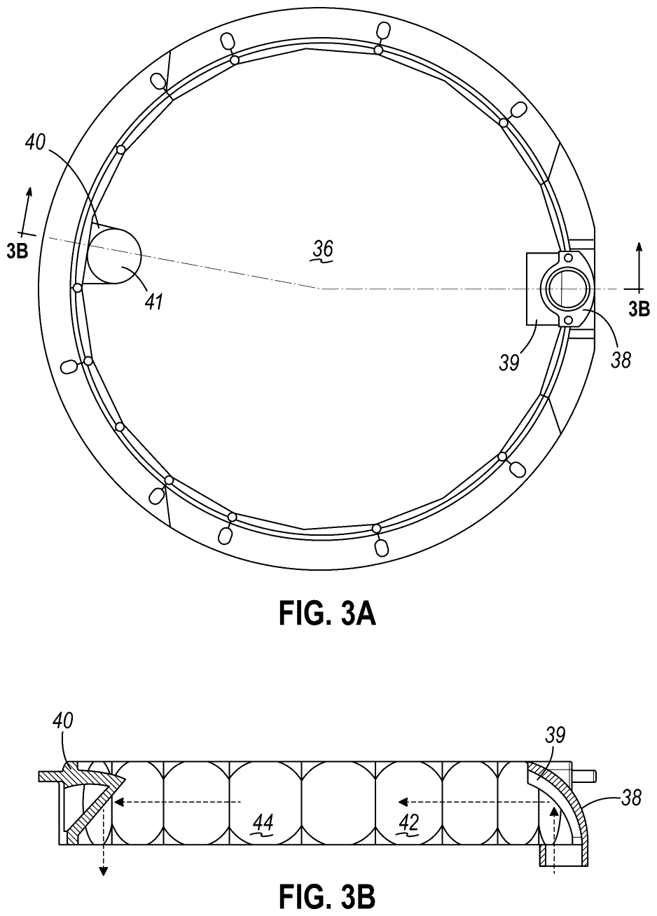

FIGS. 3A and 3B depict a top-down view and a cross-sectional view of a “Perpendicular-to-Plane” gas cell (36) showing an emitter (38) with a curved reflector (39), a detector (40), and mirrors (44) to reflect the light. FIG. 3B shows how curved reflector (39) can create a light path (42) that reflects light from emitter (38) up against curved reflector (39) and into gas cell (36). From there, the light reflects around gas cell (36) until it reaches a detector fold mirror (41). Detector fold mirror (41) may then reflect the light back out of gas cell (36) into detector (40). FIGS. 3A and 3B shows how the initial light may come from a source perpendicular to gas cell (36) itself, which may be useful in tight spaces, where the light may be coming from an outside emitter, or in other situations. The use of an Off Axis Parabola (OAP) in curved reflector (39) in front of emitter (38) in this configuration may also collect and direct more of the light/energy from emitter (38) into gas cell (36) compared to a parabolic reflector in front of emitter (38). In addition, the OAP may produce a flatter field, which may increase performance by having a uniform spatial distribution of light/energy without hot spots.

In some embodiments, an off-axis hyperbola (OAH) may be used instead of an OAP in curved reflector (39) in front of emitter (38) such that optical collection may be maximized while maintaining a uniform spatial distribution of optical power. This may include angling emitter (38) into an optical element such that more light is captured and an optical surface of the optical element may be optimized to maximize the light to another optical surface. In some embodiments, two or more OAH's may be molded into gas cell (36) such that one OAH may provide a straight path to detector (40) and one may provide a long path around gas cell (36). This may allow measurements for short path and long path measurements to occur simultaneously. Detector (40) and emitter (38) may be mounted directly into gas cell (36). In some embodiments, gas cell (36) may be molded and metalized out of three pieces.

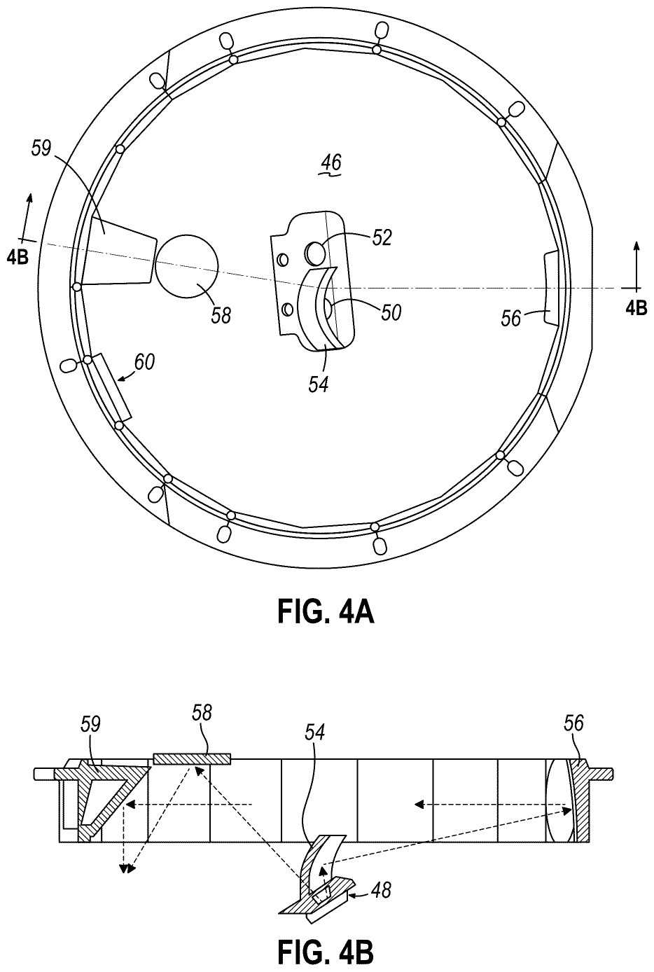

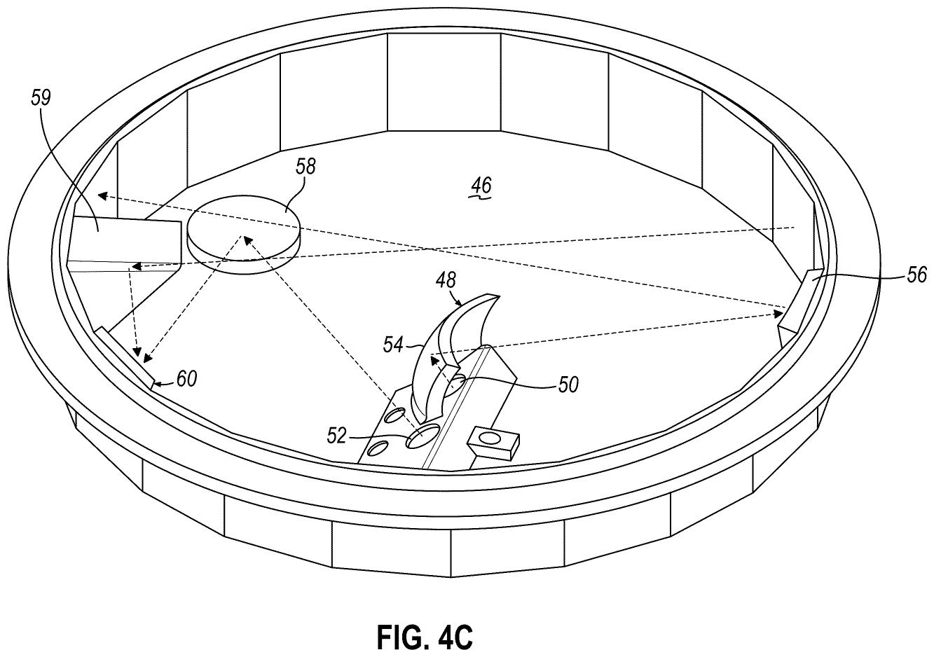

FIGS. 4A and 4B depict a top-down view and a cross-sectional view of a “At-Angle-to-Plane” gas cell (46). Gas cell (46) may include an emitter system (48) which may include a first emitter (50) and a second emitter (52). First emitter (50) emits light, or other energy, of a certain wavelength which may be reflected by an emitter curved reflector (54) into an emitter secondary reflector (56). In one or more embodiments, the emitted light from first emitter (50) may be a wavelength in the ultraviolet spectrum, within the visible spectrum, with the near infrared (about 0.75 to about 1.4 um) spectrum, within the mid-wave infrared (about 2.5 to about 6 um) spectrum, within the long-wave infrared (about 6 to about 12 um) spectrum, within the short-wave infrared (about 1.4 to about 3 um) spectrum, or combinations thereof. In one or more embodiments, first emitter (50) may use a wavelength within the mid-wave infrared and/or long-wave infrared spectrums. In one or more embodiments, gas cell (46) may allow the light from first emitter (50) to be emitted from any position relative to gas cell (46). The light from first emitter (50) may then reflect off of emitter secondary reflector (56) into gas cell (46). The light from first emitter (50) may then reflect around gas cell (46) until it ends its path by reflecting off a detector fold mirror (59) and into a detector (60) where the light from first emitter (50) can be measured to determine the level of light absorption that occurred when the light from first emitter (50) traveled through gas cell (46).

In one or more embodiments, second emitter (52) may emit light of the same wavelength as first emitter (50), which may be reflected by an emitter fold mirror (58). In one or more embodiments, second emitter (52) may emit light of the same wavelength as first emitter (5) so that the results from each can be compared and that information can be used to better determine what is being detected. If the wavelength range for each is different, then this comparison cannot occur. Emitter fold mirror (58) may then reflect the light from second emitter (52) directly into detector (60). This may create a path for the light from second emitter (52) that may be shorter than the path for the light from first emitter (50). In one or more embodiments, emitter system (48) may be positioned central to gas cell (46) to ensure that one light path, from either first emitter (50) or second emitter (52), may be longer than the light path of the other of first emitter (50) or second emitter (52). In one or more embodiments, the longer path may typically be 20 times the length of the shorter path. However, path lengths can vary significantly. In one or more embodiments, the longer path may be 50 times the length of the shorter path, 10 times the length of the shorter path, 5 times the length of the shorter path, or variations thereof. In one or more embodiments, the longer path may be from 2 to 50 times longer than the shorter path, from 10 to 100 times longer than the shorter path, or from 20 to 50 times longer than the shorter path. In one or more embodiments, the short path may allow detector (60) to get a reading with minimal or no pathlength through any gases. To detect low concentrations of a gas, a larger ratio of the length differences between the longer path to the shorter path may be needed as to optimize the right signal to noise ratio based on all the other parameters of gas cell (46) to find the detection limits needed. The Beer-Lambert Law most easily describes this phenomenon.

Chemical absorption can be proportional to the path length in the gas of interest. So, the longer the path length, the more absorption and the lower the gas levels that can be detected by a detector, such as detector (60). Generally, detectors have a certain level of noise based on the signal levels. The higher the signal levels, the less dominant the noise in the measurement. Light in a gas cell, such as gas cell (46), decreases due to its divergence and amount of time the light hits a mirror or other reflective surface. The more bounces that occur equates to more light getting lost but also the smaller the form-factor of the gas cell. In one or more embodiments, more signal can be achieved by using a more powerful emitter, but then this increases the power consumption of the device. So, a balance between the signal and noise may be found by using the Beer-Lambert Law.

The reading from detector (60) of the light of second emitter (52) may create a baseline that may include system variables that could affect the light absorption within gas cell (46), like temperature, alignment, aging, humidity, or other variables. The reading from detector (60) of the light emitted from first emitter (50) can then be compared with the reading from detector (60) of the light emitted from second emitter (52). This comparison may allow detector (60) to determine if the decrease in signal of detector (60) may be occurring from light absorption within gas cell (46) or from other system variables. Thus, detector (60) can determine an unsafe amount of gas in the environment by isolating the light absorption due to the presence of gas by comparing the light absorption of the light from first emitter (50) and the light from second emitter (52).

In some embodiments, one mirror with two or more OAHs may be used instead of detector fold mirror (58) and emitter secondary reflector (56).

In one or more embodiments, a gas cell, such as gas cell (46) may also contain a laser or a third emitter with a wavelength such that when the laser or third emitter emits light across gas cell (46), detector (60) may determine an amount of light that was scattered. Ideally, this third emitter may also be in the mid-wave infrared or long-wave infrared wavelength. Particulate matter causes light to scatter, so detector (60) could determine an unsafe amount of particulate matter.

In one or more embodiments, instead of a laser or other third emitter, a gas cell, such as gas cell (46), may contain an additional detector that detects scattered light as first emitter (50) or second emitter (52) emits light through gas cell (46). This may allow the additional detector to determine if there may be particulate matter present in gas cell (46).

From there, if excess particulate matter is identified, emitters (50, 52) may emit light of another wavelength, the wavelength being the same for both emitters (50, 52) and the process described above may be repeated. In one or more embodiments, the light of another wavelength may instead come from a third emitter, such as the one described above. In one or more embodiments, this process may be repeated to occur at multiple wavelengths such that particulate matter of different sizes can be differentiated. This can be helpful to discriminate between particles that are 1.0 microns or less in diameter (“PM 1.0”), 2.5 microns or less in diameter (“PM 2.5”), 4 microns or less in diameter (“PM 4”), and 10 microns or less in diameter (“PM 10”), each of which can be representative of different hazards including air quality, smoke, pollen, mold, allergens, and other hazards. In one or more embodiments, only two different wavelengths can be utilized to discriminate between particulate matter of different sizes by extrapolating the others. For example, PM 2.5 and PM 4 may be measured then those measurements used to extrapolate PM 1.0 and 10. However, gas cells as presently disclosed could use one, two, or any other number of different wavelengths to aid in discriminating between particulate matter of different sizes.

This may allow gas cells as presently disclosed to not only identify unsafe particulate matter in an environment, but also to differentiate between unsafe particulate matter and potentially safe particulate matter, such as particulate matter associated with changes in humidity. The detectors as presently disclosed may sense the light hitting it and produce an analog signal. That analog signal may typically be amplified and filtered with analog circuitry (for example to remove a baseline and only see a systematic signal). That signal may then be directed to an analog to digital converter (ADC) which samples the signal and converts it to digital readings which are input to a processor which measures the peaks and troughs of a pulsed signal from which the relative absorption signals and our chemical detection readings may be derived.

In one or more embodiments, this may be done by looking at one chemical channel in a water band and one chemical channel outside of the water band. By doing so, the response from water can be separated from the response from particulate matter. Humidity may also be measured by an additional humidity sensor incorporated into gas cells as presently disclosed. This may allow for the ability to disregard readings attributable to humidity. Water vapor may be measured the same way as a gas, the region where water absorbs may be examined, and that may be compared to a reference signal region and a measurement of the water vapor in the gas cell may be made. Particulates in the gas cell may affect the signal in both a chemical band and a reference band so they may be ratioed out and the particulates are not seen. Just looking at the change in the reference signal may be a measure of both the potential particulates in the system and any other system related variations. By having a secondary emitter in the system, the changes in the short path and the long path can be observed, and system related variations from particulate related signal changes can be isolated out.

While FIGS. 4A and 4B depict two emitters (50, 52), in one or more embodiments, a single emitter may be used with an optical switch to create two different optical paths instead of utilizing two separate emitters (50, 52). In one or more embodiments, the optical switch could be an optical chopper, beam splitter, redirector, or another switch. Emitter system (48) can be integrated into the assembly of gas cell (46).

FIG. 4C depicts a three-dimensional view of the “At-Angle-to-Plane” gas cell (46). In one or more embodiments, an “At-Angle-to-Plane” gas cell, such as gas cell (46), may provide better spatial distribution when compared to other embodiments. In one or more embodiments, an “At-Angle-to-Plane” gas cell, such as gas cell (46), may additionally provide increased throughput based on the positioning of an emitter system (48) in the center of gas cell (46) and angling of emitter system (48) towards an off-axis hyperbola (OAH) with compensating secondary reflector (56), to couple the light into gas cell (46). By utilizing an off-axis parabolic, a flatter field may be produced which may increase performance by having a uniform spatial distribution of light/energy without hot spots. Tipping emitter system (48) into an optical surface and making it into an OAH may increase this performance even more by collecting and directing more of the light/energy from the emitter system (48) into gas cell (46). In some embodiments, emitter system (48) may be tipped into the optical surface without the use of an OAH. In some embodiments, emitter system (48) may include a custom curve to maximize light in the gas cell.

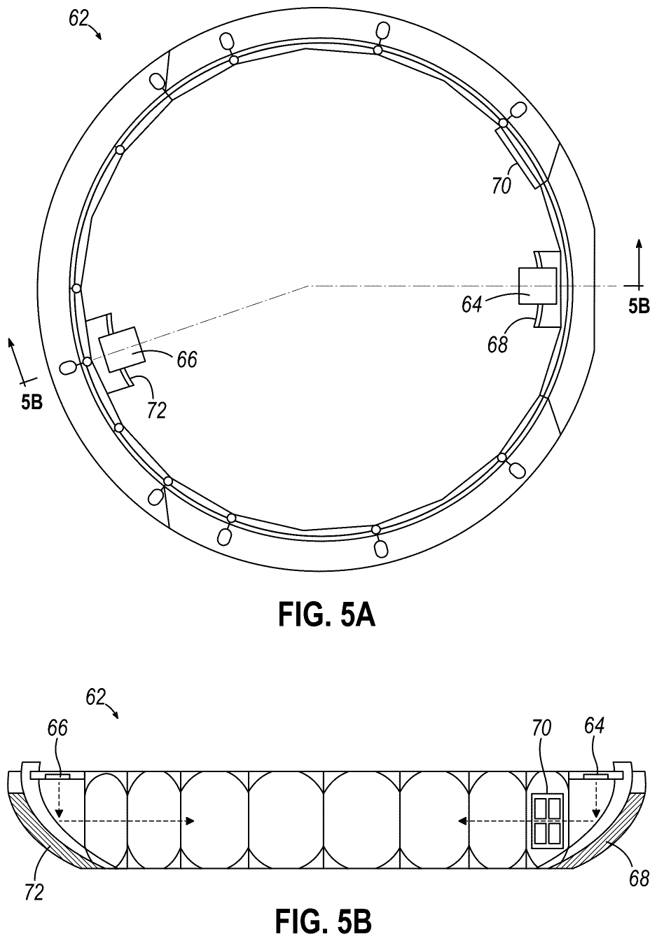

FIGS. 5A and 5B depict a top-down view and a cross-sectional view of another gas cell (62) embodiment. Gas cell (62) may include a primary emitter (64) and a secondary emitter (66). Primary emitter (64) may be mounted on or within a primary reflector (68), which may include an OAH, OAP, or another curve. Primary emitter (64) may be mounted directly beside one or more detectors (70). Secondary emitter (66) may be mounted on or within a secondary reflector (72), which may include an off-axis hyperbola, off-axis parabola, or another curve. Secondary emitter (66) may be mounted directly across gas cell (62) from one or more detectors (70). In some embodiments, primary emitter (64) may emit a longer path as described in the context of FIGS. 4A, 4B, and 4C, while secondary emitter (66) may emit a short path as described in the context of FIGS. 4A, 4B, and 4C.

### Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A gas detector for detecting multiple hazards, comprising: a gas cell; one or more energy emitters mounted within an interior of the gas cell; a plurality of mirrors along the interior of the gas cell; and one or more energy detectors capable of detecting an amount of energy.

### Example 2

The gas detector according to Example 1, wherein the one or more energy emitters emit energy in a measurable manner at a wavelength in a range where a chemical can be detected.

### Example 3

The gas detector according to Example 1, wherein the one or more energy emitters are positioned opposite of the one or more energy detectors within the gas cell.

### Example 4

The gas detector according to Example 1, wherein the plurality of mirrors comprise one or more mirrors along an interior wall of the gas cell, a curved reflector, and a detector fold mirror; and the one or more energy emitters emit light, which is reflected by the curved reflector and the one or more mirrors such that a light path is formed from the one or more energy emitters to the detector fold mirror and into the one or more energy detectors.

### Example 5

The gas detector according to Example 4, wherein the curved reflector comprises an off-axis parabola.

### Example 6

The gas detector according to Example 4, wherein the curved reflector comprises an off-axis hyperbola.

### Example 7

The gas detector according to Example 1, wherein the one or more energy emitters comprise: a primary energy emitter mounted directly beside at least one of the one or more energy detectors; and a secondary energy emitter mounted across from at least one of the one or more energy detectors.

### Example 8

The gas detector according to Example 1, further comprising a single optical cell, the single optical cell comprising two or more off-axis hyperbolas.

### Example 9

The gas detector according to Example 1, further comprising a particulate detector.

### Example 10

The gas detector according to Example 9, wherein at least one of the one or more energy emitters emits light, and the particulate detector is mounted within the gas cell and is configured to: detect scattered light within the gas cell; read an amount of scattered light within the gas cell; and determine whether particulate matter is present based on the amount of scattered light.

### Example 11

The gas detector according to Example 10, wherein the particulate detector is further configured to: trigger at least one of the one or more energy emitters to emit light at varying wavelengths; detect an amount of scattered light at each wavelength; and determine a type of particulate matter present based on the amount of scatted light at each wavelength.

### Example 12

A gas detector for detecting multiple hazards, comprising: a gas cell; a plurality of mirrors along an interior of the gas cell; one or more light detectors capable of detecting an amount of light; a short path light emitter mounted opposite a first mirror of the plurality of mirrors within the interior of the gas cell such that light from the short path light emitter reflects from the first mirror directly into at least one of the one or more light detectors; and a long path light emitter mounted within the interior of the gas cell such that the light from the long path light emitter reflects from a second mirror of the plurality of mirrors and reflects around the gas cell by the plurality of mirrors until reflecting off a third mirror of the plurality of mirrors into at least one of the one or more light detectors.

### Example 13

The gas detector according to Example 12, wherein at least one of the one or more light detectors is configured to: read an amount of light emitted from the short path light emitter; read an amount of light emitted from the long path light emitter; compare the amount of light emitted from the short path light emitter and the amount of light emitted from the long path light emitter; and determine whether an unsafe amount of gas is present in the environment based on the comparison.

### Example 14

The gas detector according to Example 12, further comprising further comprising a particulate detector.

### Example 15

The gas detector according to Example 14, wherein the particulate detector is configured to: detect scattered light within the gas cell; read an amount of scattered light within the gas cell; and determine whether particulate matter is present based on the amount of scattered light.

### Example 16

The gas detector according to Example 15, wherein the particulate detector is further configured to, if particulate matter is present: trigger the short path light emitter and the long path light emitter to emit light at varying wavelengths; detect an amount of scattered light at each wavelength; and determine a type of particulate matter present based on the amount of scatted light at each wavelength.

### Example 17

The gas detector according to Example 12, wherein the long path light emitter is mounted directly beside at least one of the one or more light detectors; and the short path light emitter is mounted across from at least one of the one or more light detectors.

### Example 18

The gas detector according to Example 12, wherein at least one of the first mirror, second mirror, and third mirror comprises an off-axis parabola.

### Example 19

The gas detector according to Example 12, wherein at least one of the first mirror, second mirror, and third mirror comprises one or more off-axis hyperbolas.

### Example 20

A method of detecting hazards comprising: emitting light of varying wavelengths into a gas cell; detecting an amount of scattered light at each wavelength; and determining a type of particulate matter present based on the amount of scattered light at each wavelength.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein can be combined may be readily apparent to those of ordinary skill in the art in view of the teachings herein. Such modifications and variations are intended to be included within the scope of the claims.

Having shown and described various embodiments of the present disclosure, further adaptations of the methods and systems described herein may be accomplished by appropriate modifications by one of ordinary skill in the art without departing from the scope of the present disclosure. Several such potential modifications have been mentioned, and others can be apparent to those skilled in the art. For instance, the examples, embodiments, geometrics, materials, dimensions, ratios, steps, and the like discussed above are illustrative and are not required. Accordingly, the scope of the present disclosure should be considered in terms of the following claims and should be understood not to be limited to the details of structure and operation shown and described in the specification and drawings.

What is claimed is:

1. A gas detector for detecting multiple hazards, comprising:
a gas cell;
one or more energy emitters mounted within an interior of the gas cell;
a plurality of mirrors along the interior of the gas cell; and
one or more energy detectors capable of detecting an amount of energy.

2. The gas detector according to claim 1, wherein the one or more energy emitters emit energy in a measurable manner at a wavelength in a range where a chemical can be detected.

3. The gas detector according to claim 1, wherein the one or more energy emitters are positioned opposite of the one or more energy detectors within the gas cell.

4. The gas detector according to claim 1, wherein the plurality of mirrors comprise one or more mirrors along an interior wall of the gas cell, a curved reflector, and a detector fold mirror; and wherein the one or more energy emitters emit light, which is reflected by the curved reflector and the one or more mirrors such that a light path is formed from the one or more energy emitters to the detector fold mirror and into the one or more energy detectors.

5. The gas detector according to claim 4, wherein the curved reflector comprises an off-axis parabola.

6. The gas detector according to claim 4, wherein the curved reflector comprises an off-axis hyperbola.

7. The gas detector according to claim 1, wherein the one or more energy emitters comprise:
a primary energy emitter mounted directly beside at least one of the one or more energy detectors; and
a secondary energy emitter mounted across from at least one of the one or more energy detectors.

8. The gas detector according to claim 1, further comprising a single optical cell, the single optical cell comprising two or more off-axis hyperbolas.

9. The gas detector according to claim 1, further comprising a particulate detector.

10. The gas detector according to claim 9, wherein at least one of the one or more energy emitters emits light, and the particulate detector is mounted within the gas cell and is configured to:
detect scattered light within the gas cell;
read an amount of scattered light within the gas cell; and
determine whether particulate matter is present based on the amount of scattered light.

11. The gas detector according to claim 10, wherein the particulate detector is further configured to:
trigger at least one of the one or more energy emitters to emit light at varying wavelengths;
detect an amount of scattered light at each wavelength; and
determine a type of particulate matter present based on the amount of scatted light at each wavelength.

12. A gas detector for detecting multiple hazards, comprising:
a gas cell;
a plurality of mirrors along an interior of the gas cell;
one or more light detectors capable of detecting an amount of light;
a short path light emitter mounted opposite a first mirror of the plurality of mirrors within the interior of the gas cell such that light from the short path light emitter reflects from the first mirror directly into at least one of the one or more light detectors; and
a long path light emitter mounted within the interior of the gas cell such that the light from the long path light emitter reflects from a second mirror of the plurality of mirrors and reflects around the gas cell by the plurality of mirrors until reflecting off a third mirror of the plurality of mirrors into at least one of the one or more light detectors.

13. The gas detector according to claim 12, wherein at least one of the one or more light detectors is configured to:
read an amount of light emitted from the short path light emitter;
read an amount of light emitted from the long path light emitter;
compare the amount of light emitted from the short path light emitter and the amount of light emitted from the long path light emitter; and
determine whether an unsafe amount of gas is present in the environment based on the comparison.

14. The gas detector according to claim 12, further comprising further comprising a particulate detector.

15. The gas detector according to claim 14, wherein the particulate detector is mounted within the gas cell and is configured to:
detect scattered light within the gas cell;
read an amount of scattered light within the gas cell; and
determine whether particulate matter is present based on the amount of scattered light.

16. The gas detector according to claim 15, wherein the particulate detector is further configured to, if particulate matter is present:
trigger the short path light emitter and the long path light emitter to emit light at varying wavelengths;
detect an amount of scattered light at each wavelength; and
determine a type of particulate matter present based on the amount of scatted light at each wavelength.

17. The gas detector according to claim 12, wherein the long path light emitter is mounted directly beside at least one of the one or more light detectors; and the short path light emitter is mounted across from at least one of the one or more light detectors.

18. The gas detector according to claim 12, wherein at least one of the first mirror, second mirror, and third mirror comprises an off-axis parabola.

19. The gas detector according to claim 12, wherein at least one of the first mirror, second mirror, and third mirror comprises one or more off-axis hyperbolas.

20. A method of detecting hazards comprising:
emitting light of varying wavelengths into a gas cell;
detecting an amount of scattered light at each wavelength; and
determining a type of particulate matter present based on the amount of scattered light at each wavelength.
